(19) United States
(12) Patent Application Publication
(10) Pub. No.: US 2011/0004333 A1
(43) Pub. Date: Jan. 6, 2011

(54) SUPERIOR CONCRETE MIX DESIGN WITH WORKABILITY OPTIMIZED GRADATION AND FIXED PASTE VOLUME

(75) Inventor: Per Just Andersen, Santa Barbara, CA (US)

Correspondence Address: Patent Docket Department;Armstrong Teasdale LLP, 7700 Forsyth Boulevard, Suite 1800, St. Louis, MO, 63105, US

(73) Assignee: ICRETE INTERNATIONAL, INC., Road Town (VG)

(21) Appl. No.: 12/496,546

(22) Filed: Jul. 1, 2009

(51) Int. Cl. G06F 17/50; G05D 11/13

(52) U.S. Cl. 700/103; 700/265

(57) ABSTRACT

Methods for design-optimization of concrete compositions having workability optimized gradation and fixed cement paste volume are disclosed. In particular, the methods allow for designing and manufacturing of concrete compositions having target compressive strengths and slumps and having a fixed volume of cement paste based on target compressive strengths and/or target slump amounts using improved methods that more efficiently utilize all the components from a performance standpoint.

### BACKGROUND OF THE DISCLOSURE

The disclosure relates generally to methods for design-optimization of concrete compositions having workability optimized gradation, thereby allowing for fixed hydraulic cement paste volume at target compressive strengths and slumps. In particular, the methods allow for designing and manufacturing of concrete compositions having target compressive strengths and slumps using a fixed volume of hydraulic cement paste using improved methods that more efficiently utilize all the components from a performance standpoint, as well as unique methods for redesigning an existing cement mix design and upgrading the batching, mixing, and/or delivery system of an existing concrete manufacturing plant.

Concrete is a ubiquitous building material. Finished concrete (also referred to herein as concrete composition) results from the hardening of an initial cementitious composition that typically comprises cement (typically, hydraulic cement), aggregate, water, and optional admixtures. The terms “concrete”, “concrete composition” and “concrete mixture” shall mean either the finished, hardened product of the initial unhardened cementitious composition or “mix design”, which is the formula or recipe used to manufacture a concrete composition. In a typical process for manufacturing transit mixed concrete, the concrete components are added to and mixed in a drum, either of a central mixer or of a standard concrete delivery truck while the truck is in transit to the delivery site. Hydraulic cement reacts with water to form a binder that hardens over time to hold the other components together.

Concrete can be designed to have varying strength, slump, and other material characteristics, which gives it broad application for a wide variety of different uses. The raw materials used to manufacture hydraulic cement and concrete are relatively inexpensive and can be found virtually everywhere, although the characteristics of the materials can vary significantly. This allows concrete to be manufactured throughout the world close to where it is needed. The same attributes that make concrete ubiquitous (i.e., low cost, ease of use, and wide availability of raw materials) have also kept it from being fully controlled and its full potential developed and exploited.

Concrete manufacturing plants typically offer and sell a number of different standard concrete compositions that vary in terms of their slump and strength. Each concrete composition is typically manufactured by following a standard mix design, or recipe, to yield a composition that has the target slump and that will harden into concrete having the target compressive strength. Unfortunately, there is often high variability between the predicted (or design) compressive strength and/or slump of a given mix design and the actual strength and/or slump between different batches with a high standard deviation in compressive strength between batches, even in the absence of substantial variability in the quality or characteristics of the raw material inputs. Part of this problem results from a fundamental disconnect between the requirements, controls and limitations of “field” operations in the concrete batch plant and the expertise from research under laboratory conditions. Whereas experts may be able to design a concrete composition having a predicted compressive strength and/or slump that closely reflects actual compressive strength and/or slump when mixed, cured and tested, experts do not typically prepare concrete compositions at concrete plants for delivery to customers. Concrete personnel who batch, mix and deliver concrete to job sites inherently lack the ability to control the typically large variation in raw material inputs that is available when conducting laboratory research. The superior knowledge of concrete by laboratory experts is therefore not readily applicable or transferable to the concrete industry in general.

In general, concrete compositions are designed based on such factors as (1) type of hydraulic cement, (2) type and quality of aggregates, (3) quantity and quality of water, and (4) climate (e.g., temperature, humidity, wind, and amount of sun, all of which can cause variability in slump, workability, and compressive strength of concrete). To guarantee a specific minimum compressive strength and slump as required by the customer (and avoid liability in the case of failure), concrete manufacturers typically follow a process referred to as “overdesign” of the concrete they sell. Specifically, under ACI 318, necessary overdesign for structural concrete is a function of the standard deviation between batches. For example, if the 28-day field compressive strength of a particular concrete mix design is known to vary by about 10%, 20%, 40%, 60%, or even more when manufactured and delivered, a manufacturer must typically provide the customer with a concrete composition based on a mix design that achieves a strength of 4000 psi when cured under controlled laboratory conditions to guarantee the customer a minimum strength of 2500 psi through the commercial process. Failure to deliver concrete having the minimum required strength can lead to structural problems, even failure, which, in turn, can leave a concrete plant legally responsible for such problems or failure. Thus, overdesigning is self insurance against delivering concrete that is too weak, with a cost to the manufacturer equal to the increased cost of overdesigned concrete. This cost must be absorbed by the owner, does not benefit the customer, and, in a competitive supply market, cannot easily be passed on to the customer.

Overdesigning typically involves adding excess hydraulic cement in an attempt to ensure a minimum acceptable compressive strength of the final concrete product at the target slump. Because hydraulic cement is typically the most expensive component of concrete (besides special admixtures that are frequently used in relatively high amounts), the practice of overdesigning concrete can significantly increase cost. However, adding more cement does not guarantee better concrete, as the cement paste or binder is often a lower compressive strength structural component compared to aggregates and is typically the component subject to the greatest dynamic variability. Overcementing can result in short term microshrinkage, excessive drying shrinkage, and long term creep. Notwithstanding the cost and potentially deleterious effects, it is current practice for concrete manufacturers to simply overdesign by adding excess hydraulic cement to each concrete composition it sells as it is easier than to try and redesign each standard mix design (which, standard practice does not allow). That is, because there is currently no reliable- or systematic way to optimize a manufacturer's pre-existing mix designs other than through time-consuming and expensive trial and error testing to make more efficient use of the hydraulic cement binder and/or account for variations in raw material inputs, manufacturers are required to adequately overdesign (e.g., overcement) the pre-existing mix designs, leading to increased costs and excessive waste of materials.

The cause of observed strength and slump variabilities is not always well understood, nor can it be reliably controlled using existing equipment and following standard protocols at typical ready-mix manufacturing plants. Typically, concrete manufacturers do not even realize that improved concrete compositions can be made with their existing equipment. Furthermore, understanding the interrelationship and dynamic effects of the different components within concrete is typically outside the capability of concrete manufacturing plant employees and concrete truck drivers using existing equipment and procedures. Moreover, what experts in the field of concrete might know, or believe they know, about concrete manufacture, cannot readily be transferred into the minds and habits of those who actually work in the field (i.e., those who place concrete mixtures into concrete delivery trucks, those who deliver the concrete to a job site, and those who place and finish the concrete at job sites) because of the tremendous difference in controls and scope of materials variation. The disconnect between what occurs in a laboratory and what actually happens during concrete manufacture can produce flawed mix designs that, while apparently optimized when observed in the laboratory, may not be optimized in reality when the mix design is scaled up to mass produce concrete over time.

Besides variability resulting from poor initial mix designs, another reason why concrete plants deliberately have to overdesign concrete is the inability to maintain consistency of manufacture. There are three major systemic causes or practices that have historically lead to substantial concrete strength variability: (1) the use of materials that vary in quality and/or characteristics; (2) the use of inconsistent batching procedures; and (3) adding insufficient batch water initially and later making slump adjustments with water at the job site, typically by the concrete truck driver adding an uncontrolled amount of water to the mixing drum. The total variation in materials and practices can be measured by standard deviation statistics.

The first cause of variability between theoretical and actual concrete strengths and slumps for a given mix design is variability in the supply of raw materials. For example, the particle size distribution, morphology, specific gravity and absorbance of aggregates (e.g., course, medium, and fine), and particle packing density of the hydraulic cement and aggregates may vary from batch to batch. Even slight differences can greatly affect how much water must be added to yield a composition having the required slump. Because concrete strength is highly dependent on the water-to-cement ratio, varying the water content to account for variations in the solid particle characteristics to maintain the required slump causes substantial variability in concrete strength. Unless a manufacturer can eliminate variations in raw material quality, overdesigning is generally the only available way to ensure that a concrete composition having the required slump also meets the minimum compressive strength requirements.

Even if a concrete manufacturer accounts for variations in raw materials' quality, overdesigning is still necessary using standard mix design tables manufactured under ACI 211. Standardized tables are based on actual mix designs using one type and morphology of aggregates that have been prepared and tested. They provide slump and strength values based on a wide variety of variables, such as amounts of cement, aggregates, water, and any admixtures, as well as the size of the aggregates. The use of standardized tables is fast and simple but can only approximate actual slump and compressive strength even when variations in raw materials are measured. That is, because the number of standardized mix designs is finite though the variability in the type, quality and amount (i.e., ratio) of raw materials is virtually infinite. Because standardized tables can only approximate real world raw material inputs, there can be significant variability between predicted and actual strength when using mix designs from standardized tables. Because of this variability, the only two options are (1) time consuming and expensive trial and error testing to find an optimal mix design for every new batch of raw materials and/or (2) overdesigning. Manufacturers typically have no other choice than overdesigning, especially in light of factors other than mix design that cause variations between design and actual strength.

The second cause of strength variability is the inability to accurately deliver the components required to properly prepare each batch of concrete. Initially, many times manufacturers are unaware that their equipment cannot accurately weight the components. Furthermore, even if modern scales can theoretically provide very accurate readings, sometimes to within 0.05% of the true or actual static weight, typical hoppers and other dispensing equipment used to dispense the components into the mixing vessel (e.g., the drum of a concrete mixer truck) are often unable to consistently open and shut at the precise time in order to ensure that the desired quantity of a given component is actually dynamically dispensed into the mixing vessel. To many concrete manufacturers, even if they realize improved concrete compositions can be made (which, noted above, most do not), the perceived cost of upgrading or properly calibrating their metering and dispensing equipment is higher than simply overdesigning the concrete, particularly since most manufacturers have no idea how much the practice of overdesigning concrete actually costs and because it is thought to be a variable cost rather than a capital cost.

The third cause of concrete strength variability is the practice by concrete truck drivers of adding water to concrete after batching in an attempt to improve or modify the concrete to make it easier to pour, pump, work, and/or finish. In many cases, concrete is uniformly designed and manufactured to have a standard slump (e.g., 1-4 inches) when the concrete truck leaves the lot, with the expectation that the final slump requested by the customer will be achieved on site through the addition of water. This procedure is imprecise because concrete drivers rarely, if ever, use a standard slump cone to actually measure the slump but simply go on “look and feel”. Since adding water significantly decreases final concrete compressive strength, the concrete plant must build in a corresponding amount of increased initial strength to offset the possible or expected decrease in strength resulting from subsequent water addition.

Furthermore, the amount of moisture in the components of a concrete composition can vary significantly depending on the specific components utilized. Specifically, depending on delivery, weather conditions, and storage conditions, total moisture in the sand and aggregate can vary substantially. Typically, a manufacturer does not have the equipment to accurately measure the moisture content within these components, and in some cases, even if the equipment is available, it is not used. Overall, this lack of instrumentation leads to a variation from batch to batch in both free water content and solids content of sand and aggregate. Because strength can be decreased by varying amounts depending on the actual amount of water added by the driver and/or unaccounted for moisture already within the components, the manufacturer must assume a worst-case scenario of maximum strength loss when designing the concrete in order to ensure that the concrete meets or exceeds the required strength.

Given the foregoing variables, which can differ in degree and scope from day to day, a concrete manufacturer may believe it to be more practical to overdesign its concrete compositions rather than account and control for the variables that can affect concrete strength, slump and other properties. Overdesigning, however, is wasteful as an inefficient use of raw materials and adds extra costs to manufacture.

Accordingly, there is a need in the art for a design-optimized concrete composition that can be prepared consistently to have a target compressive strength and slump without overcementing. That is, there is a need in the art to develop a method for optimizing a concrete mix design with workability optimized gradation and fixed hydraulic cement paste volume. It would be advantageous if the concrete composition could be made with a reduced volume of hydraulic cement to prevent the consequences of overcementing the composition.

### BRIEF DESCRIPTION OF THE DISCLOSURE

The present disclosure is generally related to methods of preparing design-optimized concrete compositions having target compressive strengths and slumps and optimized workability with a reduced cement paste volume (i.e., optimized ratio of aggregate to cement).

Accordingly, in one aspect, the present disclosure is directed to a method for designing a concrete composition having workability optimized gradation. The method comprises: defining a concrete mix design having an initial ratio of cement, water, and aggregate for optimal workability; determining a water to cement ratio to achieve a target compressive strength; determining an amount of water to be added to the concrete mix design having the target compressive strength to produce a target slump amount; and designing the concrete composition having workability optimized gradation based on the determined water to cement ratio and determined amount of water.

In another aspect, the present disclosure is directed to a method for designing a concrete composition having workability optimized gradation. The method comprises: obtaining a characterization of at least one component of a concrete mix design, the concrete mix design comprising an initial ratio of cement, water, fine aggregate, and coarse aggregate; determining a water to cement ratio to achieve a target compressive strength; determining an amount of water to be added to the concrete mix design having the target compressive strength to produce a target slump amount; preparing a concrete composition comprising the target compressive strength and target slump amount; and determining an amount of cement paste to be removed from the concrete composition having the target compressive strength and the target slump amount.

In yet another aspect, the present disclosure is directed to a method for designing a concrete composition having workability optimized gradation. The method comprises: obtaining a characterization of at least one component of a concrete mix design, the concrete mix design comprising an initial ratio of cement, water, fine aggregate, and coarse aggregate; introducing at least one moisture probe into a fine aggregate hopper and at least one moisture probe into a coarse aggregate hopper, the fine aggregate hopper used for providing the fine aggregate to the concrete mix design and the coarse aggregate hopper used for providing the coarse aggregate to the concrete mix design; determining a water to cement ratio to achieve a target compressive strength; determining an amount of water to be added to the concrete mix design having the target compressive strength to produce a target slump amount; preparing a concrete composition comprising the target compressive strength and target slump amount; and determining an amount of cement paste to be removed from the concrete composition having the target compressive strength and the target slump amount.

In another aspect, the present disclosure is directed to a system. The system comprises a memory for storing data related to a concrete mix design and a processor configured to: (1) access the data related to the concrete mix design; (2) calculate a water to cement ratio to achieve a target compressive strength; (3) calculate an amount of water to be added to the concrete mix design having the target compressive strength to produce a target slump amount; and (4) provide the calculated water to cement ratio and calculated amount of water for display.

Other objects and features will be in part apparent and in part pointed out hereinafter.

### BRIEF DESCRIPTION OF THE DRAWINGS

FIG. 1 depicts a curve for minimum and maximum workability for an exemplary concrete mix design;

FIG. 2 depicts cement paste volume as a function of concrete compressive strength for an exemplary concrete mix design having a 2-inch slump and for the concrete mix design having a constant reduced cement paste volume;

FIG. 3 depicts the maximum cement paste reduction of an exemplary concrete mix design as a function of compressive strength;

FIG. 4 depicts a “fingerprint” of compressive strength versus water to cement ratio for an exemplary manufacturer/customer; and

FIG. 5 depicts water demand for 2-inch slump as a function of water to cement ratio.

FIG. 6 depicts a system diagram of one embodiment of the present disclosure.

FIG. 7 depicts a flow chart tracking the steps of one embodiment of the present disclosure.

### DETAILED DESCRIPTION OF THE DISCLOSURE

It has been found that concrete compositions can be pre-designed and optimized such as to use minimal levels of cement paste (i.e., cement material plus water) to achieve a target compressive strength and slump. More particularly, as compared to conventional methods for designing concrete compositions according to ACI 211 using standardized tables, the methods of the present disclosure more precisely consider the actual characteristics of raw materials utilized by a concrete manufacturer. Standardized tables only roughly approximate actual slump and compressive strength because the characteristics of raw materials presumed in the tables rarely, if ever, reflect the true characteristics of raw materials actually used by a concrete manufacturer. Each concrete manufacturing plant utilizes raw materials that are unique to that plant, and it is unreasonable to expect standardized tables to accurately account for materials variability among different plants. The present methods are able to virtually “test” mix designs that more accurately reflect the raw materials actually utilized by the manufacturing plant at a given time. By accounting for variations in the quality of raw materials, the methods are able to substantially reduce the degree of overdesigning of concrete compositions that might otherwise occur using standardized mix design tables and methods. Furthermore, the methods may allow for re-designing and batching of concrete compositions in a constant and consistent manner.

As used herein, the term “concrete” refers to a composition that includes a cement paste fraction and an aggregate fraction and is an approximate Bingham fluid.

The terms “aggregate” and “aggregate fraction” refer to the fraction of concrete which is generally non-hydraulically reactive. The aggregate fraction is typically comprised of two or more differently-sized particles, often classified as fine aggregates and coarse aggregates.

As used herein, the terms “fine aggregate” and “fine aggregates” refer to solid particulate materials that pass through a Number 4 sieve (ASTM C125 and ASTM C33).

As used herein, the terms “coarse aggregate” and “coarse aggregates” refer to solid particulate materials that are retained on a Number 4 sieve (ASTM C125 and ASTM C33). Examples of commonly used coarse aggregates include ⅜ inch rock, ¾ inch rock, and 1 inch rock.

As used herein, “optimal” or “optimized” means excellent or highly desirable.

As used herein, “cementitious composition” or “cementitious mix” or “mix design” refers to concrete that has been freshly mixed together and which has not initiated hardening or has not reached initial set. Furthermore, “cementitious composition” refers to the fraction of the concrete composition comprised of water, hydraulic cement, fine aggregate, and coarse aggregate. By contrast, “dry cementitious composition” refers to the fraction of the concrete composition prior to the addition of water; that is, comprised of hydraulic cement, fine aggregate, and coarse aggregate. When blended with appropriate admixtures as disclosed herein, the cementitious composition yields an optimized concrete composition having the functional properties as described below.

As used herein, “saturated-surface-dry cementitious composition” refers to the cementitious composition or mix design including water only within the voids of an aggregate particle filled to the extent achieved by submerging in water for approximately 24 hours (but not including the voids between particles) as defined in ASTM C127 and C128.

As used herein “target strength” or “target compressive strength” refers to the target compressive strength as determined by the individual manufacturer. It should be further noted that “strength” and “compressive strength” are used interchangeably to refer to the compressive strength of a concrete composition.

As used herein, the term “segregation” refers to separation of the components of the concrete composition, particularly separation of the cement paste fraction from the aggregate fraction and/or the mortar fraction from the coarse aggregate fraction.

As used herein, the term “bleeding” refers to separation of water from the cement paste.

As used herein, the term “characterization” refers to the characteristics of one or more components of a mix design, such as functional and physical properties including sieve analysis, specific gravity of both the fine and coarse aggregate, absorption of the fine and coarse aggregates, maximum particle packing density, and the water to cement ratio typically used in the design.

As used herein, the term “workability” refers to the ability of the composition to flow (i.e., flowability) when subjected to energy input such as vibration, placement, or surface finishing.

### Overview of Exemplary Design Optimization Process

### Identifying a Concrete Mix Design for Optimal Workability

Generally, the methods of the present disclosure include first identifying a concrete mix design for optimal workability. Generally, slump is commonly used as the measure of concrete workability, e.g., as measured using ASTM-C143, and increasing the slump is understood to require less energy to position and finish the concrete. Typically, the concrete mix design includes cement, water, and aggregate.

A. Cement and Aggregate

Cements, and particularly hydraulic cements, are materials that can set and harden in the presence of water. The cement can be a Portland cement, modified Portland cement, or masonry cement. For purposes of this disclosure, Portland cement includes all cementitious compositions which have a high content of tricalcium silicate, including Portland cement, cements that are chemically similar or analogous to Portland cement, and cements that fall within ASTM specification C-150-00. Portland cement, as used in the trade, means a hydraulic cement produced by pulverizing clinker, comprising hydraulic calcium silicates, calcium aluminates, and calcium aluminoferrites, and usually containing one or more forms of calcium sulfate as an interground addition. Portland cements are classified in ASTM C 150 as Type I II, III, IV, and V. Other hydraulically settable materials include ground granulated blast-furnace slag, hydraulic hydrated lime, white cement, slag cement, calcium aluminate cement, silicate cement, phosphate cement, high-alumina cement, magnesium oxychloride cement, oil well cements (e.g., Type VI, VII and VIII), and combinations of these and other similar materials.

Pozzolanic materials such as slag, class F fly ash, class C fly ash, silica fume, and other siliceous materials can also be considered to be hydraulically settable materials (also referred to herein in combination with cement as cementitious materials) when used in combination with conventional hydraulic cements, such as Portland cement. A pozzolan is a siliceous or aluminosiliceous material that possesses cementitious value and will, in the presence of water and in finely divided form, chemically react with calcium hydroxide produced during the hydration of Portland cement to form hydratable species with cementitious properties. Diatomaceous earth, opaline, cherts, clays, shales, fly ash, silica fume, volcanic tuffs, pumices, and trasses are some of the known pozzolans. Certain ground granulated blast-furnace slags and high calcium fly ashes possess both pozzolanic and cementitious properties. Fly ash is defined in ASTM C618.

Aggregates are included in the concrete mix design to add bulk and to give the concrete composition its target strength properties. The aggregate typically includes both fine aggregate and coarse aggregate. Examples of suitable materials for coarse and/or fine aggregates include silica, quartz, crushed round marble, glass spheres, granite, limestone, bauxite, calcite, feldspar, alluvial sands, or any other durable aggregate, and mixtures thereof. In a preferred embodiment, the fine aggregate consists essentially of “sand” and the coarse aggregate consists essentially of “rock” (e.g., ⅜ inch and/or ¾ inch rock) as those terms are understood by those of skill in the art. In one aspect, the concrete mix design (and the optimized concrete composition) includes at least two separate sizes of sand and at least two separate sizes of coarse aggregate.

It should be recognized, that while discussed herein as using two sizes of coarse aggregate, the cement mix design may be produced with either solely the less coarse or solely the more coarse aggregate without departing from the present disclosure.

The amounts of the above components of the concrete mix design can be any suitable amounts for making the concrete mix design which can be processed to form a concrete composition. Generally, the amounts will be determined using a specific manufacturer's typical mix designs. Accordingly, the methods of the present disclosure can be individualized depending upon the manufacturer and its desired or target properties for the concrete composition.

Under previously used methods, such as by Fuller-Thompson and other scientists, it is believed that optimum workability of a concrete mix design can be obtained by combining fine aggregates and coarse aggregates in the concrete mix design in accordance with a continuous particle size distribution. More particularly, the ideal continuous particle size distribution gradation of fine and coarse aggregate is determined according to the Fuller-Thompson equation:

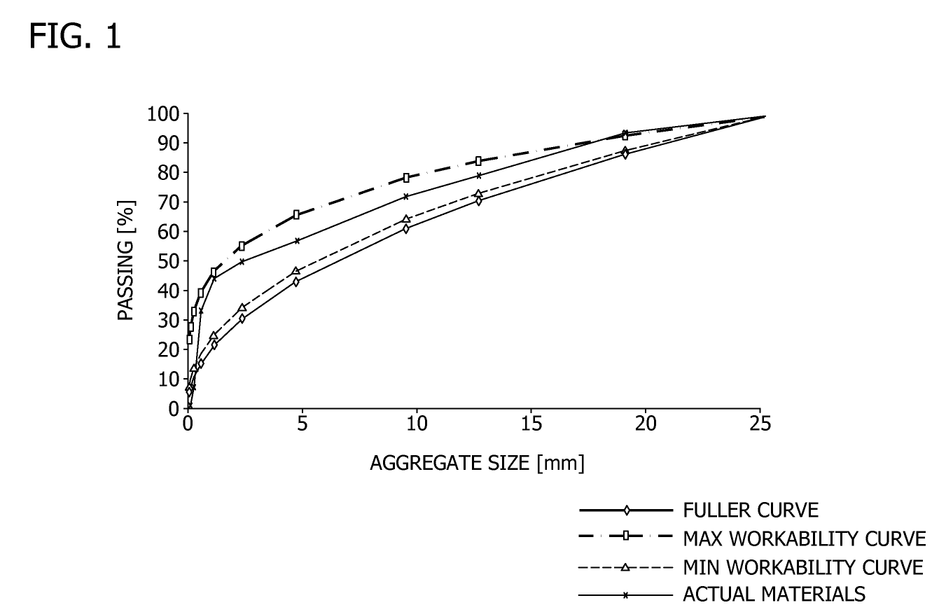

% Passing=(d/dₘₐₓ)^{0.5}

wherein % Passing is the weight percent of the aggregates passing through size (d); and dₘₐₓ is the maximum aggregate size. As an example, the above particle size distribution gradation can be plotted as shown in FIG. 1 for a maximum aggregate size of 25 mm.

In the present disclosure, it is believed that the concrete composition can have improved workability, and specifically, lower viscosity, if the particle size distribution is defined within the limits of the equations:

% Passing=(d/dₘₐₓ)^{0.25} (1)

% Passing=(d/dₘₐₓ)^{0.3+0.1[(strength-3000)/5000])} (2)

% Passing=(d/dₘₐₓ)^{(0.4+0.05[(strength-8000)/8000])} (3)

% Passing=(d/dₘₐₓ)^{0.45} (4)

It has been found that the combination of fine aggregate and coarse aggregate is dependent upon target compressive strength and/or target slump; that is, the ratio of fine aggregate to coarse aggregate is determined and/or can be adjusted to provide for a specific target compressive strength and/or target slump amount. For example, for lower strength concrete compositions, such as is when the target compressive strength is less than 3000 psi, or when zero-slump concrete compositions are desired, equation (1) is used. In another aspect, when the target compressive strength of the concrete composition is between 3000 psi and 8000 psi, equation (2) is used. In yet another aspect, when the target compressive strength of the concrete composition is between 8000 psi and 16000 psi, equation (3) is used. And, in yet another aspect, when the target compressive strength of the concrete composition is greater than 16000 psi, equation (4) is used.

By way of example, materials at an existing concrete manufacturing plant, consisting of washed concrete sand (0-4 mm), ½″ rock, and ¾″ rock, were combined in relative ratios to fit the curve of the equation:

% Passing=(d/dₘₐₓ)^{(0.3+0.1[(strength-3000)/5000])}

The result is shown as the actual materials in FIG. 1. The final concrete mix design that provided a near perfect fit to the curve consisted of 55% sand, 3.6% ½″ rock, and 41.4% 1″ rock; that is 55% fine aggregate to 45% coarse aggregate.

In another embodiment, for a concrete composition having a compressive strength of 8000 psi and above, the materials were combined in ratios to fit the curve of the equation:

% Passing=(d/dₘₐₓ)^{(0.4+0.05[(strength-8000)/8000])}

which resulted in a concrete composition including 50% sand, 4.0% ½″ rock, and 46.0% ¾″ rock; that is 50% fine aggregate to 50% coarse aggregate.

Conventional methods of preparing a concrete compositions used ACI 211 design principles, which requires individual aggregate sieve analysis to comply with ASTM C33, but never recognized the need or desire to modify particle size distribution. Moreover, even previous methods that determined particle size distribution, failed to recognize the need to adjust for a target compressive strength and/or target slump amount. Accordingly, previously made mix designs did not accurately determine and/or predict the particle size distribution gradation of fine aggregate and coarse aggregate needed to obtain concrete compositions with certain target strengths and target slumps.

It has been found that as compared to conventional concrete compositions, the concrete mix designs identified using the above equations, provide for mix designs (and concrete compositions) having a higher degree of cohesion particle packing density of the mortar phase of the mix. Additionally, by using the above equations, mix designs will have an increased volume of mortar to fill the voids between rocks as well as have a decreased porosity of mortar. As used herein, “cohesion” refers to the state of the components of the mix design sticking or adhering together.

Cohesion is generally inversely proportional to the average particle size of the aggregates as expressed by the equation:

Cohesionα1/d_{average}

By having more fine aggregate particles (e.g., sand particles) in the concrete, thereby producing a higher fine aggregate to coarse aggregate ratio, a higher degree of cohesion is achieved in the concrete mix design, allowing for a more stable composition.

Additionally, it has been found that, in most cases, the combination of fine aggregate and/or the combination of coarse aggregates that has the maximum particle packing will have a particle size distribution that matches gradation curves generated using the above described equations.

In cases with a particle gap, for example in the fine aggregate, fitting the gradation curve has been found to provide a concrete mix design (and concrete composition) with improved rheological properties rather than maximum packing. In general, fitting the region between the maximum and minimum curves has been found to provide the resulting concrete composition with minimum plastic viscosity in accordance to the Bingham plastic flow model:

τ=τ₀+ηₚₗ·γ

wherein, τ is stress; τ₀ is yield stress; ηₚₗ is plastic viscosity; and γ is shear rate. By providing a concrete composition having lower plastic viscosity at the same slump, the composition will have improved flow properties (i.e., workability) when subjected to energy input such as vibration, placement, or surface finishing.

In one or more preferred embodiments, in addition to determining optimization workability gradation, at least one or more components of the concrete mix design is further characterized to aid in identifying a concrete mix design having optimal workability. For example, in one embodiment, the manufacturer provides a characterization of one or more components of its mix design. More particularly, the manufacturer provides a manufacturer's supply material statement, which can include characterizations of properties such as, for example, a sieve analysis, specific gravity of the fine aggregate, specific gravity of the coarse aggregate, absorption of the fine aggregate, absorption of the coarse aggregate, maximum particle packing density, and the water to cement ratio typically used in the design, and the like, and combinations thereof, which can help in the identification step.

As well known in the art, specific gravity of the fine and coarse aggregates can be provided as surface-saturated-dry specific gravity; bulk specific gravity; and actual specific gravity under standard ASTM methods. As the surface-saturated-dry specific gravity measures specific gravity (ASTM C127 and C128) when the surface of the aggregate is dry and any available water is absorbed through the pores of the fine and coarse aggregate, there is no effect on strength. Accordingly, to determine excess water in a mix design, the manufacture's supply material statement desirably includes the surface-saturated-dry specific gravity for the fine aggregate, the surface-saturated-dry specific gravity for the coarse aggregate, absorption for the fine aggregate, absorption for the coarse aggregate, and combinations thereof.

Many times the manufacture's supply material statement is not sufficiently accurate. For example, as water is being absorbed through the pores of the fine and coarse aggregate, even when the aggregates appear dry, there is free water still available on the aggregates. As used herein, “free water” refers to any water that is in addition to the water absorbed through the pores of the fine and coarse aggregate, typically water resulting from delivery, weather conditions, and storage conditions. Free water can only be determined using moisture probes and similar equipment that measures total moisture:free moisture (i.e., total moisture minus absorption). Many times the supply material statement provided by the manufacture fails to consider the free water, thereby skewing the characterization of the fine and coarse aggregates. In other cases, the manufacture may not even have a supply material statement.

Accordingly, to more accurately characterize at least one or more components, in some embodiments, the methods desirably further include introducing at least one moisture probe into a fine aggregate hopper and at least one moisture probe into a coarse aggregate hopper to measure the free water available in the fine and coarse aggregate used to prepare the concrete mix design. Particularly suitable moisture probes for use in the hoppers include those commercially available as Hydro-Probe II or Hydro-Control V from Hydronix (United Kingdom).

Moreover, in many cases, to confirm the characterization of the components of the concrete mix design, the method includes preparing a test sample of the concrete mix design and comparing the sample to the characterizations received in the manufacture's supply material statements. More suitably, a plurality of test samples of the mix design are prepared and compared to the manufacture's supply material statement.

### Determining a Revised Water to Cement Ratio for a Target Compressive Strength

Once a general concrete mix design has been identified, the design is further optimized so as to produce a concrete mix design having a water to cement ratio to produce a target compressive strength. It should be noted that the water to cement ratio is typically referred to as the “equivalent water to cement ratio.” As used herein, the “target compressive strength” is any compressive strength as desired by the specific manufacture. Typically, the target compressive strength range can include any compressive strengths from about 2000 psi to about 16000 psi, and more suitably, strengths from about 3000 psi to about 12000 psi.

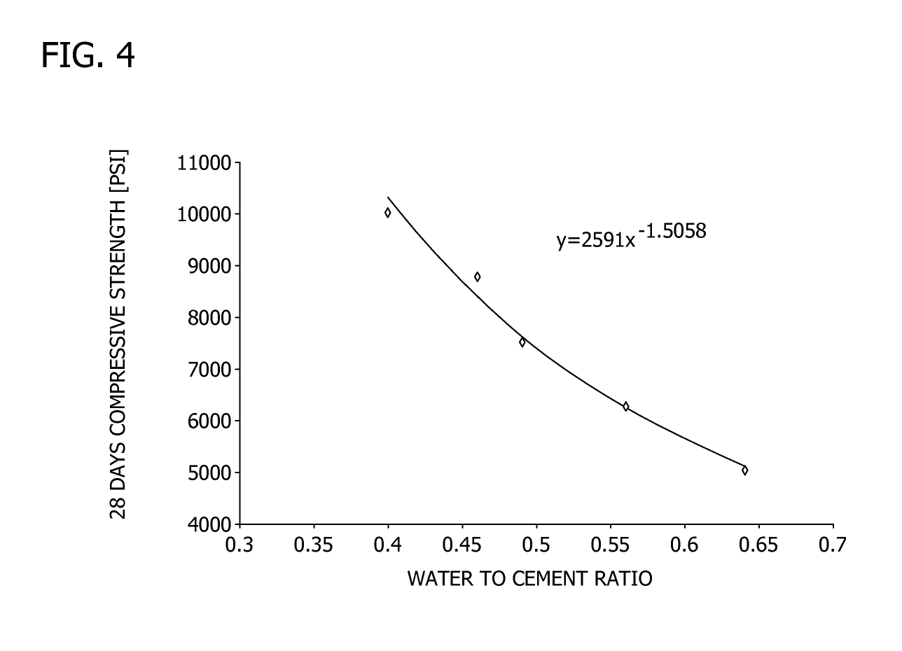

Typically, the methods should further confirm the compressive strength of the concrete mix design. For example, it has been found that the compressive strength of the optimized concrete composition decreases as the water to cement ratio increases and follows a logarithmic curve in the form of y=A×(W/C)^{-B} (also referred to herein as a strength to water:cement fingerprint). It has been found that the values for constants “A” and “B” are specific for a particular plant and are specific for a particular concrete composition; that is, when a plant chooses to use cement, and pozzolans (if any) from a specific supplier, and sand and aggregates from a specific source, a fingerprint curve results that is very specific for the chosen materials and the particular plant. This has been found true for the compressive strength after 3, 7, and 28 days, although, there is a more gradual decrease in the 3- and 7-day strength measurements as compared to the 28-day measurement. For example, in FIG. 4, the compressive strength is measured with compositions having water to cement ratios ranging from about 0.4 to about 0.65. From the curve, compressive strength for compositions having varying water to cement ratios other than shown can be calculated/predicted. This can be beneficial for use in designing mixes and concrete compositions for the existing manufacturer and/or for new customers/manufacturers. Accordingly, the compressive strength of a concrete mix design can be confirmed from data stored from a previous manufacturer.

In another embodiment, the concrete mix design can be used to prepare a concrete composition with various water to cement ratios and a fingerprint curve can be prepared. Once prepared, the concrete composition is then allowed to set and harden for a desired time period, such as for a time period of 1, 3, 7, 14, 28, 56, and 90 days. In one particularly, preferred embodiment, a plurality of concrete compositions are prepared from a concrete mix design, and then the compositions are measured for their compressive strengths. Desirably, in one or more embodiments, the compressive strength of the concrete composition is measured after 28 days.

Additionally, by generating a “fingerprint” curve for strength in relation to water to hydraulic cement ratio, the compressive strength of a particular composition at 28 days can be predicted using the strengths measured at 3 days or 7 days, and vice versa. This can be beneficial for determining the compressive strengths of compositions without having to wait the full 28 days for the composition to set and hardened, and further, can be beneficial for future designing of mixes and concrete compositions for the existing manufacturer and/or for new customers/manufacturers.

### Determining an Amount of Water to be Added to the Concrete Mix Design to Product a Target Slump Amount

The water demand for a certain target slump amount of a concrete mix design having a particular combination of fine and coarse aggregates, such as the concrete mix design used herein, is typically a function of particle shape, surface texture, particle size distribution and particle packing density. Additionally, the cementitious materials (e.g., hydraulic cement and other pozzolanic materials) used in the mix will have an effect on the amount of water to produce a target slump amount.

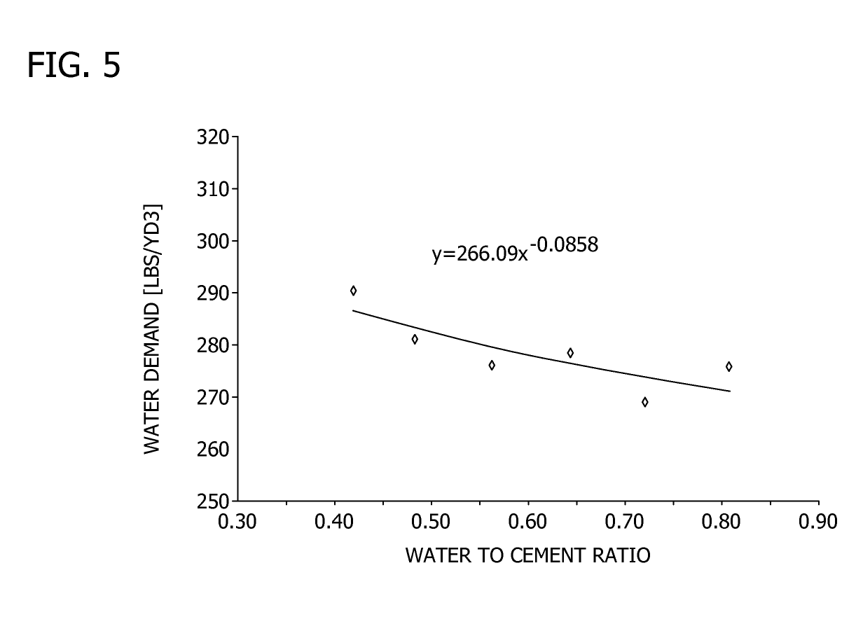

Initially, water is added to the concrete mix design according to the water to hydraulic cement ratio determined above. Water is then slowly and continuously added to the mix until a target slump amount is achieved. “Water demand” is defined as the amount of water above saturated-surface-dry (SSD) conditions of the aggregates to be added to one cubic yard of a concrete composition that, for a given set of materials consisting of hydraulic cement, pozzolanic materials, one or more fine aggregates, and one or more coarse aggregates, provides a target slump amount of 2 inches. A 2-inch slump is generally chosen as it is desirable to keep the slump as low as possible because lower water demand requires less cement for all water-to-cement ratios, reducing costs, and further because the slump is easily measured. Additionally, by requiring the slump to be above 0, the amount of plasticizer is reduced which guarantees adequate cohesion of the cement at higher dosage rates. Typically, to determine the water demand, either a fingerprint curve is used from a previous customer or a series of increasing water to cement ratios that is known from experience to provide strengths in the target range are chosen. For example, as shown in FIG. 5, water demand for a 2-inch slump for concrete compositions made with the same materials over a water to hydraulic cement ratio of from approximately 0.3 to approximately 0.8 typically varies only within about 20 pounds of water. If water demand is assumed to be constant over the entire range, then it has been found that the maximum error generated is approximately ±1 inch of slump. Accordingly, a benchmark slump of 2 inches±1 inch is typically used to determine water demand (i.e., amount of water required).

In cases in which the initial amount of water added, according to the water to cement ratio produces a slump that is greater than desired, the amount of water required to achieve the target slump amount can be determined using formula (I):

$${W}_{2} = \frac{{W}_{1}}{{( {S}_{1} \text{/} {S}_{2} )}^{0.085}}$$

W₂ is the amount of water necessary for obtaining the target slump amount. W₁ is the amount of water that has been added to the concrete mix design. S₁ is the current slump of the concrete mix design with the water added, and S₂ is the target slump amount.

Additionally, once the amount of water to be added to a concrete mix design is determined, a concrete composition can be designed using the amount of water for a particular target slump and having the target compressive strength.

In some embodiments, plasticizers are further added to the concrete mix design (and to the concrete composition) to achieve the target slump amount. More specifically, no additional water is added; that is, slump is adjusted to the target slump amount solely using plasticizer (which has no effect of the compressive strength of the composition). Exemplary plasticizers (also referred to herein as dispersants) are typically used in concrete compositions to increase flowability without adding water. Dispersants can be used to lower the water content in the concrete composition to increase strength and/or obtain higher slump without adding additional water. A dispersant, if used, can be any suitable dispersant such as lignosulfonates, beta naphthalene sulfonates, sulfonated melamine formaldehyde condensates, polyaspartates, polycarboxylates with and without polyether units, naphthalene sulfonate formaldehyde condensate resins, or oligomeric dispersants. Depending on the type of dispersant, the dispersant may be characterized as a high range water reducer, fluidizer, antiflocculating agent, and/or superplasticizer.

One class of dispersants includes mid-range water reducers. These dispersants are often used to improve the finishability of concrete flatwork. Mid-range water reducers should at least meet the requirements for Type A in ASTM C 494.

Another class of dispersants includes high range water-reducers (HRWR). These dispersants are capable of reducing water content of a given fresh concrete mix by as much as 10% to 50%. HRWRs can be used to increase strength or to greatly increase the slump to produce a “flowing” concrete composition without adding additional water. HRWRs that can be used in the present disclosure include those covered by ASTM C 494 and types F and G, and Types 1 and 2 in ASTM C 1017. Examples of HRWRS are described in U.S. Pat. No. 6,858,074.

### Designing the Concrete Composition Having Workability Optimized Gradation Based on the Determined Water to Cement Ratio and Determined Amount of Water

Once the amount of water to be added to the concrete mix design having the target compressive strength to produce a target slump amount is determined, the concrete composition having workability optimized gradation based on the determined water to cement ratio and determined amount of water may optionally be designed. In one embodiment of the present disclosure, this design may include amassing all of the relevant data determined in the process and collating this data into a work sheet suitable for use by a technician, operator, engineer, or another in preparing concrete. This design step may also include the introduction of other admixtures into the concrete composition.

In another embodiment, the designing may include the preparation of a mass balance or similar sheet properly balancing the components of the concrete for further use by a technician, operator, or engineer, or another. The designing of the concrete may be carried out, in one suitable embodiment, by a computer or computer system as described herein.

As would be recognized by one skilled in the art based on the disclosure herein, it is within the scope of the present disclosure for the entity designing the concrete to either utilize the design itself to make concrete, or for the entity to simply design the concrete and then send or provide the design to a technician, operator, engineer or another to prepare the concrete.

### Providing the Concrete Composition

In another embodiment of the present disclosure, once the amount of water to be added to the concrete mix design having the target compressive strength to produce a target slump amount is determined and the concrete composition designed, it may be provided. In some embodiments, the term “provided” or “providing” means that the designed concrete composition is: (1) provided for storage in, for example, a computer memory designed for storage of data; (2) provided for display on, for example, a screen such as an liquid crystal display (LCD) screen or touch screen; and/or (3) provided to a technician, operator, engineer or other person for the purpose of making or otherwise using the concrete composition.

Determining an Amount of Cement Paste to be Removed from the Concrete Composition

Once prepared, an amount of cement paste (i.e., cementitious materials plus water) may be removed from the concrete composition having the target compressive strength and target slump amount. Conventionally, the cohesion of a concrete composition is secured through the addition of excess hydraulic cement volume, however, in spite of high cement paste volumes, the result is often that with increases in slump (e.g., target slump above 8 inches achieved with adding excess plasticizer), the concrete composition segregates or bleeds excessively.

It has now been found that it is possible with the concrete mix design identified using the optional particle size distribution gradation curves to obtain an improved cohesion and workability of the resulting concrete composition; that is the method of the present disclosure allows the amount of cement paste to remain constant for concrete compositions with a target strength of greater than 3000 psi to about 12000 psi or even higher. With concrete compositions with target strengths of 3000 psi or less, there is no cement paste reduction as these compositions require as much cohesion as possible.

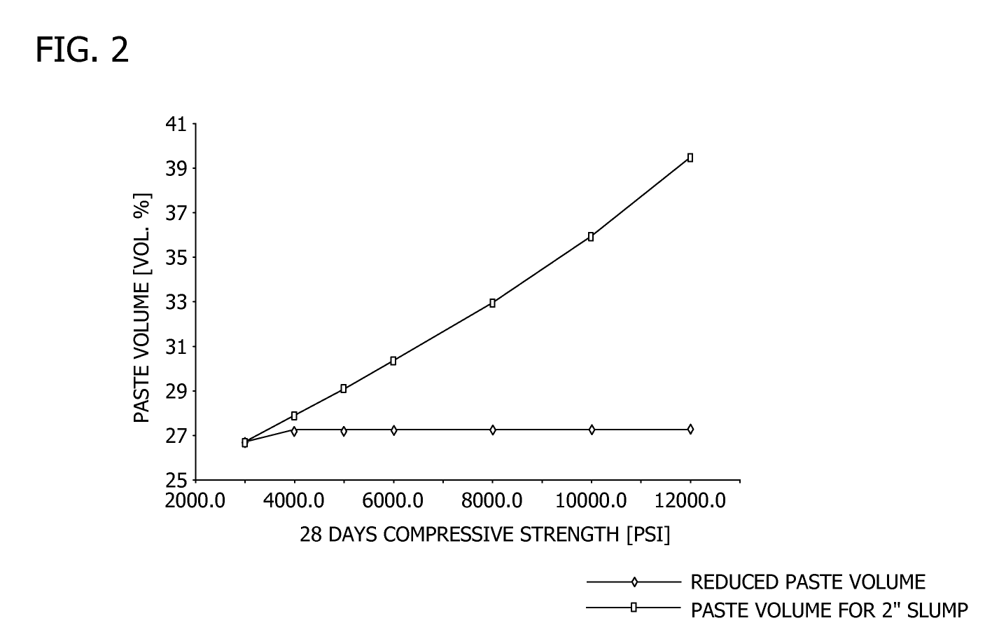

In one or more particularly preferred embodiments, the amount of paste to be removed or reduced from the concrete composition can be determined by plotting the maximum cement paste reduction versus target compressive strength. For example, as shown in FIG. 2, the cement paste volume for a 2-inch slump increases when increasing the strength from about 3000 psi to about 12000 psi. With the optimized gradation as determined above, however, the cement paste volume can be kept constant from 4000 psi to 12000 psi-strength concrete compositions. That is, for the embodiment as shown in FIG. 2, the target slump amount of the concrete composition can be adjusted with plasticizer to a target slump amount of about 8 or more inches while still maintaining good cohesion and superior flow properties without segregation. If the concrete composition stability needs to be increased, the cement paste content for any strength can be increased back towards the 2-inch curve.

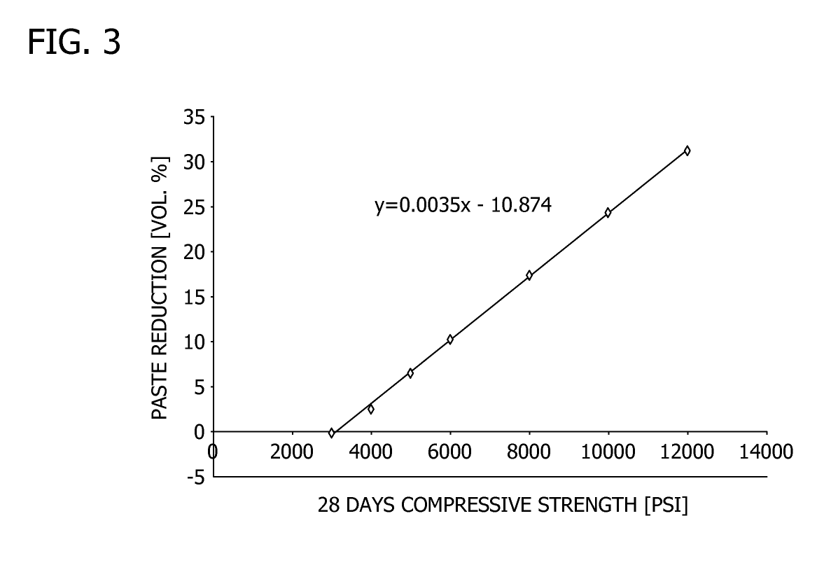

Generally, it has been found that the higher the target strength of a concrete composition, the more cement paste volume can be reduced below the amount required for a 2-inch slump (see FIG. 3). This relationship can be described by the equation:

% Maximum Cement Paste Reduction=0.0035×Strength (PSI)−10.874

### Admixtures and Fillers

In one or more preferred embodiments, once the concrete composition is designed, the mix can be altered to include a wide variety of admixtures and fillers to give the concrete composition various desired or targeted properties. Examples of admixtures that can be used in the compositions include, but are not limited to, air entraining agents, strength enhancing amines and other strengtheners, dispersants, water reducers, superplasticizers, water binding agents, rheology-modifying agents, viscosity modifiers, corrosion inhibitors, pigments, wetting agents, water soluble polymers, water repellents, strengthening fibers, permeability reducers, pumping aids, fungicidal admixtures, germicidal admixtures, insecticidal admixtures, finely divided mineral admixtures, alkali reactivity reducer, bonding admixtures, and mixtures thereof.

Air-entraining agents are compounds that entrain microscopic air bubbles in freshly mixed concrete compositions (i.e., concrete compositions), which then harden into concrete (e.g., hardened optimized concrete compositions) having microscopic air voids. Entrained air dramatically improves the durability of concrete exposed to moisture during freeze thaw cycles and greatly improves resistance to surface scaling caused by chemical deicers. Air-entraining agents can also reduce the surface tension of a composition at low concentration. Air entrainment can also increase the workability of compositions and reduce segregation and bleeding. Examples of suitable air-entraining agents include wood resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, inorganic air entrainers, synthetic detergents, the corresponding salts of these compounds, and mixtures of these compounds. Air-entraining agents are added in an amount to yield a desired level of air in a fresh concrete mix. Generally, the amount of air entraining agent in a composition ranges from about 0.2 to about 6 fluid ounces per hundred pounds of dry cement. Weight percentages of the primary active ingredient of the air-entraining agents (i.e., the compound that provides the air entrainment) are about 0.001% to about 0.1%, based on the weight of concrete composition. The particular amount used will depend on materials, mix proportion, temperature, and mixing action.

In yet another alternative embodiment, the concrete composition does not include any air entraining agent but rather a greater quantity of superplasticizer, as discussed herein.

Strength enhancing amines are compounds that improve the compressive strength of concrete made from hydraulic cement mixes (e.g., Portland cement concrete compositions). The strength enhancing amine includes one or more compounds from the group selected from poly(hydroxyalkylated)polyethyleneamines, poly(hydroxyalkylated)poly-ethylenepolyamines, poly(hydroxyalkylated)polyethyleneimines, poly(hydroxyl-alkylated)polyamines, hydrazines, 1,2-diaminopropane, polyglycoldiamine, poly-(hydroxylalkyl)amines, and mixtures thereof. An exemplary strength enhancing amine is 2,2,2,2 tetra-hydroxydiethylenediamine.

Viscosity modifying agents (VMA), also known as rheological modifiers or rheology modifying agents, can be added to the concrete composition produced in the present disclosure. These additives are usually water-soluble polymers and function by increasing the apparent viscosity of the mix water. This enhanced viscosity facilitates uniform flow of the particles and reduces bleed, or free water formation, on the fresh paste surface.

Suitable viscosity modifying agents that can be used in the present disclosure include, for example, cellulose ethers (e.g., methylcellulose, hydroxyethylcellulose, hydroxypropylmethylcellulose, carboxymethylcellulose, carboxymethylhydroxyethyl cellulose, methylhydroxyethylcellulose, hydroxymethylethylcellulose, ethylcellulose, hydroxyethylpropylcellulose, and the like); starches (e.g., amylopectin, amylose, seagel, starch acetates, starch hydroxy-ethyl ethers, ionic starches, long-chain alkylstarches, dextrins, amine starches, phosphates starches, and dialdehyde starches); proteins (e.g., zein, collagen and casein); synthetic polymers (e.g., polyvinylpyrrolidone, polyvinylmethyl ether, polyvinyl acrylic acids, polyvinyl acrylic acid salts, polyacrylimides, ethylene oxide polymers, polylactic acid polyacrylates, polyvinyl alcohol, polyethylene glycol, and the like); exopolysaccharides (also known as biopolymers, e.g., welan gum, xanthan, rhamsan, gellan, dextran, pullulan, curdlan, and the like); marine gums (e.g., algin, agar, seagel, carrageenan, and the like); plant exudates (e.g., locust bean, gum arabic, gum karaya, tragacanth, ghatti, and the like); seed gums (e.g., guar, locust bean, okra, psyllium, mesquite, and the like); starch-based gums (e.g., ethers, esters, and related derivatized compounds). See, for example, Shandra, Satish and Ohama, Yoshihiko, “Polymers In Concrete”, published by CRC press, Boca Ration, Ann Harbor, London, Tokyo (1994).

Viscosity modifying agents are typically used with water reducers in highly flowable mixtures to hold the fresh concrete mix and concrete composition together. Viscosity modifiers can disperse and/or suspend components of the composition thereby assisting in holding the composition together.

Corrosion inhibitors in concrete compositions serve to protect embedded reinforcing steel from corrosion due to its highly alkaline nature. The highly alkaline nature of the concrete composition causes a passive and non-corroding protective oxide film to form on the steel. However, carbonation or the presence of chloride ions from deicers or seawater can destroy or penetrate the film and result in corrosion. Corrosion-inhibiting admixtures chemically arrest this corrosion reaction. Examples of materials used to inhibit corrosion include calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete composition that have low cement contents, high water-cement ratios, or a deficiency of fines in the aggregate. These admixtures retard moisture penetration into dry concrete and include certain soaps, stearates, and petroleum products.

Permeability reducers are used to reduce the rate at which water under pressure is transmitted through the concrete composition. Silica fume, fly ash, ground slag, natural pozzolans, water reducers, and latex can be employed to decrease the permeability of the concrete composition.

Pumping aids are added to concrete compositions to improve pumpability. These admixtures thicken the fluid concrete, i.e., increase its viscosity, to reduce de-watering of the paste while it is under pressure from the pump. Among the materials used as pumping aids in fresh concrete mixes are organic and synthetic polymers, hydroxyethylcellulose (HEC) or HEC blended with dispersants, organic flocculents, organic emulsions of paraffin, coal tar, asphalt, acrylics, bentonite and pyrogenic silicas, natural pozzolans, fly ash and hydrated lime.

Other additives can include accelerating agents and retarding agents. An accelerating agent is added to a concrete composition to initiate hardening of the composition. Accelerating agents, also referred to as accelerators, are admixtures that increase the rate of cement hydration. Examples of accelerators include, but are not limited to, nitrates of alkali metals, alkaline earth metals, or aluminum; nitrites of alkali metals, alkaline earth metals, or aluminum; thiocyanates of alkali metals, alkaline earth metals, or aluminum; thiosulphates of alkali metals, alkaline earth metals, or aluminum; hydroxides of alkali metals, alkaline earth metals, or aluminum; carboxylic acid salts of alkali metals, alkaline earth metals, or aluminum (such as calcium formate); and halide salts (such as bromides) of alkali metals or alkaline earth metals. One particularly preferred accelerating agent to be used in the concrete composition includes Pozzolith® NC534, commercially available from BASF, The Chemical Company, Cleveland, Ohio.

Retarding agents, also known as retarders, delayed-setting or hydration control admixtures, are used to retard, delay, or slow the rate of cement hydration. They can be added to the initial concrete composition upon initial batching or sometime after the hydration process has begun. Examples of retarding agents include lignosulfonates and salts thereof, hydroxylated carboxylic acids, borax, gluconic acid, tartaric acid, mucic acid, and other organic acids and their corresponding salts, phosphonates, monosaccharides, disaccharides, trisaccharides, polysaccharides, certain other carbohydrates such as sugars and sugar-acids, starch and derivatives thereof, cellulose and derivatives thereof, water-soluble salts of boric acid, water-soluble silicone compounds, sugar-acids, and mixtures thereof. Exemplary retarding agents are commercially available under the tradename Delvo®, from Masterbuilders (a division of BASF, The Chemical Company, Cleveland, Ohio).

Bacteria and fungal growth on or in hardened concrete compositions may be partially controlled through the use of fungicidal, germicidal, and insecticidal admixtures. Examples of such materials include polyhalogenated phenols, dialdrin emulsions, and copper compounds.

Fibers can be distributed throughout a concrete composition to strengthen it. Upon hardening, this concrete composition is referred to as fiber-reinforced concrete. Fibers can be made of zirconium materials, carbon, steel, fiberglass, or synthetic polymeric materials, e.g., polyvinyl alcohol (PVA), polypropylene (PP), nylon, polyethylene (PE), polyester, rayon, high-strength aramid (e.g., p- or m-aramid), or mixtures thereof.

Shrinkage reducing agents include but are not limited to alkali metal sulfate, alkaline earth metal sulfates, alkaline earth oxides, e.g., sodium sulfate and calcium oxide.

Finely divided mineral admixtures are materials in powder or pulverized form added to compositions before or during the mixing process to improve or change some of the plastic or hardened properties of Portland cement concrete. The finely divided mineral admixtures can be classified according to their chemical or physical properties as: cementitious materials; pozzolans; pozzolanic and cementitious materials; and nominally inert materials. Nominally inert materials include finely divided raw quartz, dolomites, limestones, marble, granite, and others.

Alkali-reactivity reducers can reduce the alkali-aggregate reaction and limit the disruptive expansion forces in hardened concrete. Pozzolanic materials (fly ash and silica fume), blast-furnace slag, salts of lithium, and barium are especially effective.

Bonding admixtures are usually added to cement mixtures to increase the bond strength between old and new concrete and include organic materials such as rubber, polyvinyl chloride, polyvinyl acetate, acrylics, styrene-butadiene copolymers, and powdered polymers.

Natural and synthetic admixtures are used to color concrete compositions for aesthetic and safety reasons. Coloring admixtures are usually composed of pigments and include carbon black, iron oxide, phthalocyanine, umber, chromium oxide, titanium oxide and cobalt blue.

In some embodiments, as described above, other pozzolanic materials, such as slag, fly ash, silica fume, and the like, and combinations thereof, can be combined with hydraulic cement to form the cement component (e.g., cementitious material) of the concrete mix design. Cement, slag, fly ash, silica fumes, and the other pozzolanic materials all have a “strength activity coefficient” when compared to the strength of a reference cement. The “strength activity coefficient” identifies the equivalent weight (referred to herein as “equivalent cementitious material weight”) of the cement material that will be required to provide the same strength as the pozzolanic material and will vary depending on the producer of the cement and pozzolanic material. In some cases, significant differences can be seen even in the strength capability of different sources of a pozzolanic material.

Accordingly, if using a combination of cementitious materials, such as hydraulic cement and other pozzolanic materials, the amount of all of the cementitious materials (e.g., “equivalent cementitious material weight) must be determined for the concrete mix design (and concrete composition) to have optimized workability as described above. By way of example, the following reactivity coefficients can be used for the various pozzolanic materials:

Cement: (a)=1.0
Slag: (b)=1.0
Fly ash class C: (c)=0.5
Fly ash class F: (d)=0.3
Silica Fume: (e)=2.0
While exemplary reactivity coefficients are shown above, it should be recognized that coefficients can vary from plant to plant.

For a particular concrete mix design (and concrete composition), the “equivalent cementitious material weight” can be calculated from the equation:

Cementitious Material_{eq}=(weight of cement×a)+(weight of slag×b)+(weight of fly ash C×c)+(weight of fly ash F×d)+(weight of silica fume×e)

Using the above equation, the same strength “fingerprint curve” can be used for various different concrete compositions interchangeably.

Additionally, the SSD weight composition for a particular design can be calculated as follows:

Water=WD−Water Reduction

Cement_{eq}=Water/Required w/c

Slag=% Slag×(Cement_{eq}/100)

Fly Ash C=% Fly Ash C×(Cement_{eq}/100)

Fly Ash F=% Fly Ash F×(Cement_{eq}/100)

Volume Sand+Aggregate=vol/yd³−vol Cement−vol Slag−vol Fly Ash C−vol Fly Ash F−Water−Air

Weight Sand=% Sand×(Volume Sand+Aggregate)/100×Sand SSD Specific Gravity

Weight Rock=% Rock×(Volume Sand+Aggregate)/100×Rock SSD Specific Gravity

### Exemplary Operating Environment

A computer, computer system, and/or computing device such as described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer or hand-held device. Although described in connection with an exemplary computing system environment, embodiments of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment. Examples of well known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein. Aspects of the disclosure may also be practiced in distributed computing environments where tasks are performed by remote processing devices that are linked through a communications network. In a distributed computing environment, program modules may be located in both local and remote computer storage media including memory storage devices.

The embodiments illustrated and described herein as well as embodiments not specifically described herein but within the scope of aspects of the disclosure constitute exemplary means for making various concretes.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

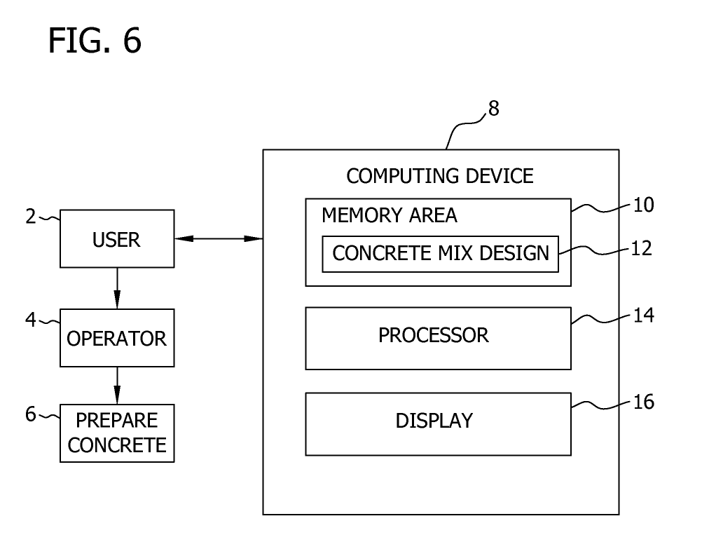

Referring now to FIG. 6, there is shown a system diagram of one embodiment of the present disclosure, including a user 2 in communication with a computing device 8 including a memory area 10, a processor 14 and a display 16. The memory area 10 includes concrete mix design information 12. The user 2 is also shown in communication with an operator 4 who may prepare concrete 6.

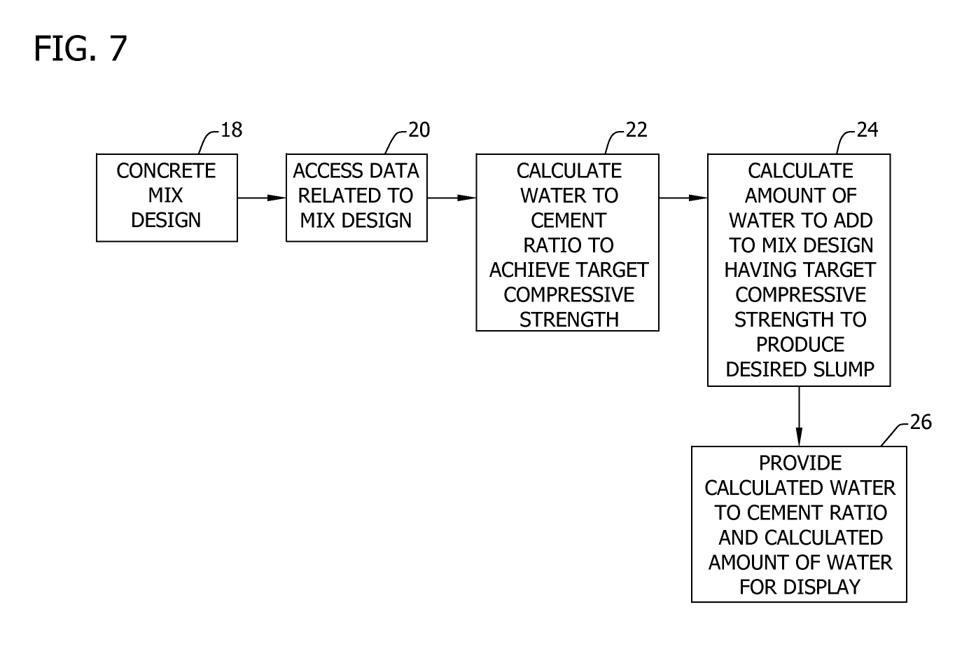

Referring now to FIG. 7, there is shown a flow chart showing one embodiment of the present disclosure including accessing data 20 related to a mix design 18 and then calculating a water to cement ratio to achieve a target compressive strength 22, calculating an amount of water to add to the mix design having a target compressive strength to produce a target slump 24, and then providing the calculated water to cement ratio and calculated amount of water for display 26.

Having described the disclosure in detail, it will be apparent that modifications and variations are possible without departing from the scope of the disclosure defined in the appended claims.

### EXAMPLES

The following non-limiting examples are provided to further illustrate the present disclosure.

It should be noted that in all Examples, the data from a previously obtained fingerprint curve (FIG. 4) determined from previous mix designs run at the various plants where used. This previous fingerprint curve showed that the required water to cement ratio to meet strength requirements with an over-design between about 10-15% were as follows: 0.690, 0.604, 0.537, 0.483, 0.397, 0.330, and 0.275 for 3000 psi, 4000 psi, 5000 psi, 6000 psi, 8000 psi, 10000 psi, and 12000 psi mix designs, respectively.

The fine and coarse aggregate materials all had similar gradations in the Examples, which resulted in optimal gradations for mix designs below 8000 psi of 55% (by weight) sand, 3.6% (by weight) ½″ rock, and 41.4% (by weight) 1″ rock, and for mix designs above 8000 psi of 50% sand, 4.0% (by weight) ½″ rock, and 46.0% (by weight) 1″ rock. As the fine and coarse aggregate materials were different in the different plants (e.g., shape and texture), and different cementitious combinations were used for the same equivalent fingerprint curve, the mix designs of the Examples have different water demands from Example to Example. In each Example, the basic water demand for a 2-inch slump was determined for the 3000 psi mix design as part of the setup mix designs.

### Example 1

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed to determine the effects of cement paste reduction and substituting other pozzolanic materials for hydraulic cement.

To begin, various mixes pre-existing concrete mix designs, each having a target compressive strength ranging from 3000 to 12000 psi, were identified. Particularly, the revised water to hydraulic cement ratios were determined using fingerprint curves for the existing designs as described above.

Once prepared, the concrete compositions were analyzed to determine the minimal amount of water (i.e., water demand) for a 2-inch slump. Particularly, the water demand for a 2-inch slump was determined by adding water until a 2-inch slump was observed. Plasticizer was then added to achieve the final target slump amount, which in the instant Example was 8 inches. As shown in the Tables below, for the various compositions having different materials, the water demand requirements varied substantially. Particularly, it was determined that the water demand ranged from 271 lbs/yd³ to about 325 lbs/yd³ for the various plants.

The compositions were also analyzed for cement paste reduction for their respective target strengths. The maximum percent reduction is calculated as described above. The various mix designs and analyses of these designs are shown in Table 1.

TABLE 1
Plant 1's Final Mix Designs (Water demand = 308 lbs/yd³)
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.5 | 6.5 | 10.3 | 17.4 | 24.3 | 31.0 |
| Reduction | | | | | | | |
| (%) | | | | | | | |
| Strength | 3000 | 4000 | 5000 | 6000 | 8000 | 10000 | 120000 |
| (PSI) | | | | | | | |
| Cement | 446 | 497 | 536 | 572 | 641 | 707 | 773 |
| (lbs/yd³) | | | | | | | |
| Sand 1 (0.1-4 mm) | 1726 | 1714 | 1714 | 1714 | 1558 | 1558 | 1558 |
| (lbs/yd³) | | | | | | | |
| ½″ Rock | 113 | 112 | 112 | 112 | 124 | 124 | 124 |
| (lbs/yd³) | | | | | | | |
| 1″ Rock | 1294 | 1285 | 1285 | 1285 | 1428 | 1428 | 1428 |
| (lbs/yd³) | | | | | | | |
| Water | 308 | 300 | 288 | 276 | 254 | 233 | 213 |
| (lbs/yd³) | | | | | | | |
| Approx. | 34.3 | 34.9 | 37.5 | 40.1 | 44.8 | 49.4 | 53.9 |
| Plasticizer | | | | | | | |
| (fl.oz/yd³) | | | | | | | |
| Air | 2 | 2 | 2 | 2 | 2 | 2 | 2 |
| (Vol. %) | | | | | | | |
| w/c ratio | 0.690 | 0.604 | 0.537 | 0.483 | 0.397 | 0.330 | 0.275 |
| Unit weight | 143.9 | 144.7 | 145.7 | 146.6 | 148.3 | 150.0 | 151.7 |
| (lbs/ft³) | | | | | | | |
| Paste vol. | 203.9 | 207.7 | 207.7 | 207.7 | 207.7 | 207.7 | 207.7 |
| (l/yd³) | | | | | | | |
| Paste(Vol. | 26.7 | 27.7 | 27.2 | 27.2 | 27.2 | 27.2 | 27.2 |
| %) | | | | | | | |
| Paste with | 28.7 | 29.2 | 29.2 | 29.2 | 29.2 | 29.2 | 29.2 |
| Air | | | | | | | |
| (Vol. %) | | | | | | | |

### Example 2

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 2.

TABLE 2
Plant 2's Final Set-up Mix Designs
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.4 | 6.4 | 10.2 | 17.3 | 24.1 | 30.9 |
| Reduction | | | | | | | |
| (%) | | | | | | | |
| Strength | 3000 | 4000 | 5000 | 6000 | 8000 | 10000 | 12000 |
| (PSI) | | | | | | | |
| Cement | 413 | 460 | 496 | 530 | 594 | 656 | 716 |
| (lbs/yd³) | | | | | | | |
| Sand 1 | 1774 | 1762 | 1762 | 1762 | 1602 | 1602 | 1602 |
| (0.1-4 mm) | | | | | | | |
| (lbs/yd³) | | | | | | | |
| ½″ Rock | 116 | 115 | 115 | 115 | 128 | 128 | 128 |
| (lbs/yd³) | | | | | | | |
| 1″ Rock | 1330 | 1321 | 1321 | 1321 | 1468 | 1468 | 1468 |
| (lbs/yd³) | | | | | | | |
| Water | 285 | 278 | 267 | 256 | 236 | 216 | 197 |
| (lbs/yd³) | | | | | | | |
| Approx. | 31.7 | 32.2 | 34.7 | 37.0 | 41.4 | 45.6 | 49.8 |
| Plasticizer | | | | | | | |
| (fl.oz/yd³) | | | | | | | |
| Air | 2 | 2 | 2 | 2 | 2 | 2 | 2 |
| (Vol. %) | | | | | | | |
| w/c ratio | 0.690 | 0.604 | 0.537 | 0.483 | 0.397 | 0.330 | 0.275 |
| Unit | 145.1 | 145.8 | 146.7 | 147.6 | 149.2 | 150.7 | 152.2 |
| weight | | | | | | | |
| (lbs/ft³) | | | | | | | |
| Paste vol. | 188.7 | 192.5 | 192.5 | 192.5 | 192.5 | 192.5 | 192.5 |
| (l/yd³) | | | | | | | |
| Paste | 24.7 | 25.2 | 25.2 | 25.2 | 25.2 | 25.2 | 25.2 |
| (Vol. %) | | | | | | | |
| Paste with | 26.7 | 27.2 | 27.2 | 27.2 | 27.2 | 27.2 | 27.2 |
| Air | | | | | | | |
| (Vol. %) | | | | | | | |

### Example 3

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 3.

TABLE 3
Plant 3's Final Set-up Mix Designs
Cement Mix Designs having Strengths from 3000 PSI to 8000 PSI

| | Mix 1 | Mix 2 | Mix 3 | Mix 4 | Mix 5 |
|---|---|---|---|---|---|
| | (3000 psi) | (4000 psi) | (5000 psi) | (6000 psi) | (8000 psi) |
| Paste | 0.0 | 2.4 | 6.4 | 10.2 | 17.3 |
| Reduction | | | | | |
| (%) | | | | | |
| Strength | 3000 | 4000 | 5000 | 6000 | 8000 |
| (PSI) | | | | | |
| Cement | 393 | 438 | 472 | 504 | 565 |
| (lbs/yd³) | | | | | |
| Sand 1 | 1706 | 1695 | 1695 | 1695 | 1541 |
| (0.1-4 mm) | | | | | |
| (lbs/yd³) | | | | | |
| ½″ Rock | 111 | 111 | 111 | 111 | 123 |
| (lbs/yd³) | | | | | |
| 1″ Rock | 1279 | 1271 | 1271 | 1271 | 1412 |
| (lbs/yd³) | | | | | |
| Water | 271 | 265 | 254 | 243 | 224 |
| (lbs/yd³) | | | | | |
| Approx. Air | 4 | 4 | 4 | 4 | 4 |
| Entrainment | | | | | |
| Agent | | | | | |
| (fl.oz/yd³) | | | | | |
| Approx. | 30.2 | 30.6 | 32.9 | 35.2 | 39.4 |
| Plasticizer | | | | | |
| (fl.oz/yd³) | | | | | |
| Air | 6 | 6 | 6 | 6 | 6 |
| (Vol. %) | | | | | |
| w/c ratio | 0.690 | 0.604 | 0.537 | 0.483 | 0.397 |
| Unit weight | 139.3 | 140.0 | 140.8 | 141.6 | 143.2 |
| (lbs/ft³) | | | | | |
| Paste vol. | 179.4 | 183.0 | 183.0 | 183.0 | 183.0 |
| (l/yd³) | | | | | |
| Paste (Vol. | 23.5 | 23.9 | 23.9 | 23.9 | 23.9 |
| %) | | | | | |
| Paste with | 29.5 | 29.9 | 29.9 | 29.9 | 29.9 |
| Air | | | | | |
| (Vol. %) | | | | | |

### Example 4

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 4.

TABLE 4
Plant 4's Final Set-up Mix Designs
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.4 | 6.5 | 10.4 | 17.6 | 24.5 | 31.3 |
| Reduction | | | | | | | |
| (%) | | | | | | | |
| Strength | 3000 | 4000 | 5000 | 6000 | 8000 | 10000 | 120000 |
| (PSI) | | | | | | | |
| Cement | 256 | 286 | 308 | 329 | 368 | 405 | 442 |
| (lbs/yd³) | | | | | | | |
| Slag | 171 | 191 | 205 | 219 | 245 | 270 | 295 |
| (lbs/yd³) | | | | | | | |
| Sand 1 | 1722 | 1709 | 1709 | 1709 | 1553 | 1553 | 1553 |
| (0.1-4 mm) | | | | | | | |
| (lbs/yd³) | | | | | | | |
| ½″ Rock | 112 | 111 | 111 | 111 | 124 | 124 | 124 |
| (lbs/yd³) | | | | | | | |
| 1″ Rock | 1291 | 1281 | 1281 | 1281 | 1423 | 1423 | 1423 |
| (lbs/yd³) | | | | | | | |
| Water | 295 | 288 | 276 | 264 | 243 | 223 | 203 |
| (lbs/yd³) | | | | | | | |
| Approx. | 32.8 | 33.3 | 35.9 | 38.4 | 43.1 | 47.5 | 51.9 |
| Plasticizer | | | | | | | |
| (fl.oz/yd³) | | | | | | | |
| Air | 3 | 3 | 3 | 3 | 3 | 3 | 3 |
| (Vol. %) | | | | | | | |
| w/c ratio | 0.690 | 0.604 | 0.537 | 0.483 | 0.397 | 0.330 | 0.275 |
| Unit | 142.5 | 143.2 | 144.1 | 144.9 | 146.5 | 148.1 | 149.6 |
| weight | | | | | | | |
| (lbs/ft³) | | | | | | | |
| Paste vol. | 197.5 | 201.5 | 201.5 | 201.5 | 201.6 | 201.6 | 201.6 |
| (l/yd³) | | | | | | | |
| Paste | 25.8 | 26.4 | 26.4 | 26.4 | 26.4 | 26.4 | 26.4 |
| (Vol. %) | | | | | | | |
| Paste with | 28.8 | 29.4 | 29.4 | 29.4 | 29.4 | 29.4 | 29.4 |
| Air | | | | | | | |
| (Vol. %) | | | | | | | |

### Example 5

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 5.

TABLE 5
Plant 5's Final Set-up Mix Designs
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.4 | 6.5 | 10.4 | 17.6 | 24.5 | 31.3 |
| Reduction | | | | | | | |
| (%) | | | | | | | |
| Strength | 3000 | 4000 | 5000 | 6000 | 8000 | 10000 | 120000 |
| (PSI) | | | | | | | |
| Cement | 234 | 261 | 281 | 300 | 336 | 370 | 404 |
| (lbs/yd³) | | | | | | | |
| Slag | 180 | 200 | 216 | 230 | 258 | 284 | 310 |
| (lbs/yd³) | | | | | | | |
| Class C | 70 | 78 | 84 | 90 | 101 | 111 | 121 |
| Fly Ash | | | | | | | |
| (lbs/yd³) | | | | | | | |
| Sand 1 | 1668 | 1652 | 1650 | 1649 | 1496 | 1492 | 1490 |
| (0.1-4 mm) | | | | | | | |
| (lbs/yd³) | | | | | | | |
| ½″ Rock | 109 | 108 | 108 | 107 | 119 | 119 | 119 |
| (lbs/yd³) | | | | | | | |
| 1″ Rock | 1251 | 1239 | 1238 | 1236 | 1371 | 1368 | 1365 |
| (lbs/yd³) | | | | | | | |
| Water | 310 | 303 | 290 | 278 | 255 | 234 | 213 |
| (lbs/yd³) | | | | | | | |
| Approx. | 34.5 | 35.0 | 37.8 | 40.4 | 45.3 | 49.9 | 54.5 |
| Plasticizer | | | | | | | |
| (fl.oz/yd³) | | | | | | | |
| Air | 3 | 3 | 3 | 3 | 3 | 3 | 3 |
| (Vol. %) | | | | | | | |
| w/c ratio | 0.690 | 0.604 | 0.537 | 0.483 | 0.397 | 0.330 | 0.275 |
| Unit | 141.6 | 142.3 | 143.2 | 144.1 | 145.8 | 147.4 | 148.9 |
| weight | | | | | | | |
| (lbs/ft³) | | | | | | | |
| Paste vol. | 202.4 | 206.1 | 205.7 | 205.3 | 204.5 | 203.9 | 203.2 |
| (l/yd³) | | | | | | | |
| Paste | 26.5 | 27.0 | 26.9 | 26.9 | 26.8 | 26.7 | 26.6 |
| (Vol. %) | | | | | | | |
| Paste with | 29.5 | 30.0 | 29.9 | 29.9 | 29.8 | 29.7 | 29.6 |
| Air | | | | | | | |
| (Vol. %) | | | | | | | |

### Example 6

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 6.

TABLE 6
Plant 6's Final Set-up Mix Designs
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.4 | 6.5 | 10.4 | 17.3 | 24.5 | 31.3 |
| Reduction | | | | | | | |
| (%) | | | | | | | |
| Strength | 3000 | 4000 | 5000 | 6000 | 8000 | 10000 | 120000 |
| (PSI) | | | | | | | |
| Cement | 409 | 456 | 492 | 525 | 589 | 647 | 706 |
| (lbs/yd³) | | | | | | | |
| Class C | 123 | 137 | 147 | 157 | 177 | 194 | 212 |
| Fly Ash | | | | | | | |
| (lbs/yd³) | | | | | | | |
| Sand 1 | 1628 | 1611 | 1608 | 1605 | 1453 | 1451 | 1447 |
| (0.1-4 mm) | | | | | | | |
| (lbs/yd³) | | | | | | | |
| ½″ Rock | 106 | 105 | 105 | 105 | 116 | 116 | 115 |
| (lbs/yd³) | | | | | | | |
| 1″ Rock | 1221 | 1208 | 1206 | 1204 | 1331 | 1330 | 1326 |
| (lbs/yd³) | | | | | | | |
| Water | 325 | 317 | 304 | 291 | 269 | 245 | 223 |
| (lbs/yd³) | | | | | | | |
| Approx. | 36.2 | 36.7 | 39.6 | 42.3 | 47.2 | 52.3 | 57.1 |
| Plasticizer | | | | | | | |
| (fl.oz/yd³) | | | | | | | |
| Air | 3 | 3 | 3 | 3 | 3 | 3 | 3 |
| (Vol. %) | | | | | | | |
| w/c ratio | 0.690 | 0.604 | 0.537 | 0.483 | 0.397 | 0.330 | 0.275 |
| Unit | 141.2 | 142.0 | 143.0 | 144.0 | 145.7 | 147.5 | 149.2 |
| weight | | | | | | | |
| (lbs/ft³) | | | | | | | |
| Paste vol. | 206.4 | 209.5 | 208.6 | 207.7 | 206.8 | 204.5 | 202.9 |
| (l/yd³) | | | | | | | |
| Paste | 27.0 | 27.4 | 27.3 | 27.2 | 27.0 | 26.7 | 26.5 |
| (Vol. %) | | | | | | | |
| Paste with | 30.0 | 30.4 | 30.3 | 30.2 | 30.0 | 29.7 | 29.5 |
| Air | | | | | | | |
| (Vol. %) | | | | | | | |

### Example 7

In this Example, concrete design mixes were optimized to yield improved workability and target compressive strength and slump with a fixed cement paste volume. More particularly, pre-existing mix designs, having water to cement ratios for producing target compressive strengths and target slump amounts, were analyzed as in Example 1 to determine the effects of cement paste reduction and substituting other pozzolanic materials for hydraulic cement.

The various mix designs and analyses of these designs are shown in Table 7.

TABLE 7
Plant 7's Final Set-up Mix Designs
Cement Mix Designs having Strengths from 3000 PSI to 12000 PSI

| | Mix 1 | Mix 2 | Mix 3 | Mix 4 | Mix 5 | Mix 6 | Mix 7 |
|---|---|---|---|---|---|---|---|
| | (3000 psi) | (4000 psi) | (5000 psi) | (6000 psi) | (8000 psi) | (10000 psi) | (12000 psi) |
| Paste | 0.0 | 2.4 | 6.5 | 10.3 | 17.3 | 24.5 | 31.3 |
| Reduction | | | | | | | |
| (%) | | | | | | | |
| Strength | 3000 | 4000 | 5000 | 6000 | 8000 | 10000 | 120000 |
| (PSI) | | | | | | | |
| Cement | 381 | 425 | 458 | 489 | 549 | 603 | 657 |
| (lbs/yd³) | | | | | | | |
| Class F | 114 | 128 | 137 | 147 | 165 | 181 | 197 |
| Fly Ash | | | | | | | |
| (lbs/yd³) | | | | | | | |
| Sand 1 | 1690 | 1672 | 1667 | 1663 | 1503 | 1498 | 1492 |
| (0.1-4 mm) | | | | | | | |
| (lbs/yd³) | | | | | | | |
| ½″ Rock | 110 | 109 | 109 | 108 | 120 | 119 | 119 |
| (lbs/yd³) | | | | | | | |
| 1″ Rock | 1267 | 1253 | 1250 | 1247 | 1377 | 1373 | 1367 |
| (lbs/yd³) | | | | | | | |
| Water | 287 | 280 | 268 | 257 | 237 | 217 | 197 |
| (lbs/yd³) | | | | | | | |
| Approx. | 31.9 | 32.4 | 35.0 | 37.4 | 41.7 | 46.2 | 50.4 |
| Plasticizer | | | | | | | |
| (fl.oz/yd³) | | | | | | | |
| Air | 3 | 3 | 3 | 3 | 3 | 3 | 3 |
| (Vol. %) | | | | | | | |
| w/c ratio | 0.690 | 0.604 | 0.537 | 0.483 | 0.397 | 0.330 | 0.275 |
| Unit | 142.6 | 143.2 | 144.1 | 144.9 | 146.3 | 147.8 | 149.3 |
| weight | | | | | | | |
| (lbs/ft³) | | | | | | | |
| Paste vol. | 185.1 | 188.2 | 187.7 | 187.1 | 186.7 | 185.1 | 184.1 |
| (l/yd³) | | | | | | | |
| Paste | 24.2 | 24.6 | 24.5 | 24.5 | 24.4 | 24.2 | 24.1 |
| (Vol. %) | | | | | | | |
| Paste with | 27.2 | 27.6 | 27.5 | 27.5 | 27.4 | 27.2 | 27.1 |
| Air | | | | | | | |
| (Vol. %) | | | | | | | |

As shown in Examples 1-7 (Tables 1-7), as the concrete compositions were optimized for fine to coarse aggregate gradation (i.e., workability) as described above, the cement paste volume could remain constant for the compositions having a target strength of from greater than 3000 psi to about 12000 psi. As shown in FIG. 2, the cement paste volume for a 2-inch slump for the example mixes shown in Table 1 increases from 26.7% to 39.4% when increasing the strength from 3000 psi to 12000 psi. With strengths between about 4000 psi and 12000 psi, however, the cement paste volume is maintained constant at about 27.2%. Furthermore, by adjusting the slump of the concrete composition with plasticizer to the target slump (e.g., a slump of 8 inches in this case), the concrete compositions still maintain good cohesion without segregation and superior flow properties.

As various changes could be made in the above constructions and methods without departing from the scope of the disclosure, it is intended that all matter contained in the above description and shown in the accompanying drawings shall be interpreted as illustrative and not in a limiting sense.

1. A method for designing a concrete composition having workability optimized gradation, the method comprising:
defining a concrete mix design having an initial ratio of cement, water, and aggregate for optimal workability;
determining a water to cement ratio to achieve a target compressive strength; and
determining an amount of water to be added to the concrete mix design having the target compressive strength to produce a target slump amount; and
designing the concrete composition having workability optimized gradation based on the determined water to cement ratio and determined amount of water.

2. The method as set forth in claim 1 further comprising providing the designed concrete composition.

3-5. (canceled)

6. The method as set forth in claim 1 wherein the designing is done utilizing a computer.

7-8. (canceled)

9. The method as set forth in claim 1 wherein the identifying of a concrete mix design will depend on at least one of the target compressive strength and the target slump amount.

10. The method as set forth in claim 1 wherein the determining of the water to cement ratio comprises evaluating a fingerprint curve obtained by plotting compressive strength after a desired time versus a ratio of water to cement of the concrete mix design.

11. The method as set forth in claim 1 wherein the amount of water to be added to the concrete mix design comprises adding an amount of water until the target slump amount is achieved.

12. The method as set forth in claim 1 further comprising preparing a concrete composition comprising the target compressive strength and the target slump amount.

13. (canceled)

14. The method as set forth in claim 12 further comprising determining an amount of cement paste to be removed from the concrete composition having the target compressive strength and the target slump amount.

15. The method as set forth in claim 14 wherein the determining an amount of cement paste to be removed comprises plotting a maximum cement reduction versus compressive strength.

16-20. (canceled)

21. A method for designing a concrete composition having workability optimized gradation, the method comprising:
obtaining a characterization of at least one component of a concrete mix design, the concrete mix design comprising an initial ratio of cement, water, fine aggregate, and coarse aggregate;
determining a water to cement ratio to achieve a target compressive strength;
determining an amount of water to be added to the concrete mix design having the target compressive strength to produce a target slump amount;
preparing a concrete composition comprising the target compressive strength and target slump amount; and
determining an amount of cement paste to be removed from the concrete composition having the target compressive strength and the target slump amount.

22. The method as set forth in claim 21 further comprising removing cement paste from the concrete composition to produce the concrete composition having workability optimized gradation.

23. The method as set forth in claim 21 wherein the characterization of at least one component of the concrete mix design comprises characterizing a property selected from the group consisting of sieve analysis, specific gravity of fine aggregate, specific gravity of coarse aggregate, absorption of fine aggregate, absorption of coarse aggregate, maximum particle packing density, water to cement ratio, and combinations thereof.

24. (canceled)

25. The method as set forth in claim 21 further comprising identifying the concrete mix design based upon at least one of the target compressive strength range and the target slump amount.

26. (canceled)

27. The method as set forth in claim 21 wherein the determining of a water to cement ratio comprises evaluating a fingerprint curve obtained by plotting compressive strength after a desired time versus a ratio of water to cement of the concrete mix design.

28-29. (canceled)

30. The method as set forth in claim 21 wherein the determining an amount of cement paste to be removed comprising plotting a maximum cement reduction versus compressive strength.

31-50. (canceled)

51. A system comprising:
a memory for storing data related to a concrete mix design; and
a processor configured to:
access the data related to the concrete mix design;
calculate a water to cement ratio to achieve a target compressive strength;
calculate an amount of water to be added to the concrete mix design having the target compressive strength to produce a target slump amount; and
provide the calculated water to cement ratio and calculated amount of water for display.

52. The system as set forth in claim 51 wherein the processor is additionally configured to evaluate a fingerprint curve to determine the water to cement ratio.

53. The system as set forth in claim 51 wherein the processor is additionally configured to provide a material balance sheet for preparing a concrete composition comprising the target compressive strength and the target slump amount.

54. The system as set forth in claim 51 wherein the processor is additionally configured to determine an amount of cement paste to be removed from the concrete composition having the target compressive strength and the target slump amount.

55. The system as set forth in claim 51 wherein the processor is additionally configured to determine an amount of equivalent cementitious material comprising hydraulic cement and the separate pozzolanic material for use in the concrete mix design.

56. (canceled)
